(19) United States
(12) Patent Application Publication
(10) Pub. No.: US 2023/0228671 A1
(43) Pub. Date: Jul. 20, 2023

(54) RECTANGULAR CELL FOR PHOTOMETRIC ANALYSIS

(71) Applicant: YEP CO.,LTD., Kyoto-shi, Kyoto (JP)

(72) Inventors: Kenji YUASA, Kyoto (JP); Takayuki IGARASHI, Kyoto (JP)

(21) Appl. No.: 17/768,510

(22) PCT Filed: Oct. 15, 2019
(86) PCT No.: PCT/JP2019/040488

§ 371 Date: Feb. 22, 2023

(51) Int. Cl. G01N 21/15

(52) U.S. Cl. CPC G01N 21/15

(57) ABSTRACT

A rectangular cell is a bottomed rectangular cell mounted in a photometric analyzer, and has an opening at a top end face for accommodating a test sample to be analyzed. The rectangular cell has a low flat area that is lower than an upper flat area on an inner face on a lower side of an outer face of a wall surface through which a measurement light from the analyzer is transmitted when the rectangular cell is mounted in the analyzer. This low area extends substantially over the entire width in the horizontal direction. When the rectangular cell is mounted in a recess in the photometric analyzer, an area through which the measurement light passes in the rectangular cell is not damaged by dust, even if fine hard dust adheres to the side surface of the recess. Further, the low region can have a mirror-finished surface by polishing.

### TECHNICAL FIELD

This invention relates to a bottomed rectangular cell that is mounted in a photometric analyzer and has an opening at a top end face for accommodating a test sample to be analyzed.

### BACKGROUND ART

Known in the art is a technique referred to as spectroscopic analysis by which a spectrum of light emitted or absorbed by a substance, hereinafter referred to as a test sample, is analyzed to identify components of the test sample (in this application, “light” is not limited to visible light and means an electromagnetic wave whose straightness is the same as or greater than that of visible light). A device for performing the spectroscopic analysis (hereinafter, referred to as “spectroscopic analyzer”) identifies components in a test sample to be analyzed, by irradiating the test sample to be analyzed with a measurement light in a predetermined frequency band, and by examining a spectrum of light emitted from the test sample to be analyzed irradiated with the measurement light. In this application, “photometry” means identifying characteristics of light such as a spectrum of the light.

In an analyzer for analysis of components of a test sample to be analyzed by photometry such as by use of a spectroscopic analyzer or the like, there is used a rectangular cylindrical container, referred to as rectangular cell, that has a bottom and a top end face, which enables the test sample to be analyzed to be held at a position where measurement light is irradiated. FIGS. 11A to 11E (collectively referred to as FIG. 11) both show the shape of a rectangular cell 5 according to the prior art.

FIG. 11A is a perspective view of the rectangular cell 5, FIG. 11B is a plan view of the rectangular cell 5, FIG. 11C is a front view or a rear view of the rectangular cell 5, FIG. 11D is a right side view or a left side view of the rectangular cell 5, and FIG. 11E is a bottom view of the rectangular cell 5.

In FIG. 11A, the bottom end face of the rectangular cell 5 is closed and the top end face thereof is open. In FIG. 11A, the y direction indicates the direction in which the measurement light of the analyzer is irradiated, after insertion of the rectangular cell 5 into the analyzer.

The side wall 51 and the side wall 52 shown in FIG. 11B face each other with the y direction (the direction in which the measurement light is irradiated) being the normal direction. The outer surface 511 and the inner surface 512 of the side wall 51, and the outer surface 521 and the inner surface 522 of the side wall 52 are polished to be mirror-finished surfaces, to eliminate bending and reflection of the measurement light as much as possible. The region a shown in FIG. 11C is a region of the rectangular cell 5 through which the measurement light of the analyzer is transmitted after mounting of the rectangular cell 5 in the analyzer.

The rectangular cell 5 according to the prior art is subject to a problem in that the region a of the cell is susceptible to scratching when the rectangular cell 5 is mounted in the analyzer. FIGS. 12A-12D illustrate this problem. FIG. 12A schematically illustrates how the rectangular cell 5 is mounted in the analyzer 6. That is, when the rectangular cell 5 is mounted in the analyzer 6, it is mounted from the closed-bottom end face side into the rectangular prism-shaped recess D provided in the analyzer 6.

FIG. 12B is a schematic side view showing the analyzer 6 and the rectangular cell 5 before mounting of the rectangular cell 5 in the analyzer 6. Dust 7, which is a hard substance such as very fine sand particles, adheres to the side surface of the recess D of the analyzer 6 shown in FIG. 12B. FIG. 12C illustrates the analyzer 6 shown in FIG. 12B after mounting of the rectangular cell 5 in the recess D. FIG. 12D is a perspective view of the rectangular cell 5 after being mounted in the recess D of the analyzer 6, as shown in FIG. 12B. As shown in FIG. 12D, the outer surface 511 of the side wall 51 of the rectangular cell 5 has scratches S caused by dust 7 when the rectangular cell 5 is mounted in recess D of the analyzer 6. On the outer surface 511 of the side wall 51 of the rectangular cell 5, scratches S are caused by the dust 7, when the rectangular cell 5 is mounted in the recess D of the analyzer 6. As described above, when the region through which the measurement light of the outer surface 511 or the outer surface 521 is transmitted becomes scratched, accuracy of a result of analysis made by the analyzer 6 is reduced. It is thus necessary to discard the scratched rectangular cell 5 and replace it with a new one.

A technique for solving the above-mentioned problem of scratching of the rectangular cell according to the prior art has been proposed. For example, Patent Document 1 discloses a glass rectangular cell (rectangular glass cell) in which a region that is recessed from a periphery is provided on the outer surface of a region of the rectangular cell through which the measurement light is transmitted. According to the rectangular glass cell disclosed in Patent Document 1, if dust adheres to the side surface of the recess of the analyzer in which the rectangular glass cell is mounted, the region of the outer surface of the rectangular cell through which the measurement light is transmitted becomes scratched by the dust upon insertion of the rectangular glass cell.

### PRIOR ART DOCUMENT

### Patent Document

Patent Document 1: JP H10-273331A

### Problem to Be Solved by the Invention

With a rectangular glass cell having a recess in a region on the outer surface through which measurement light is transmitted, as disclosed in Patent Document 1, it is difficult to perform a process of forming the recess in the region and to process the outer surface of the recessed region to have a mirror-finished surface. As a result, it is not possible to mass-produce a rectangular glass cell having a recess in the region through which measurement light is transmitted on the outer surface, as disclosed in Patent Document 1.

In view of the above circumstances, it is an object of the present invention to provide a rectangular cell that can be mass-produced and is not prone to scratching of a region on the outer surface through which measurement light is transmitted when the rectangular cell is mounted in the analyzer.

### SUMMARY

To solve the above-mentioned problems, the present invention provides, as a first aspect, a bottomed rectangular cell that is mounted in a photometric analyzer and has an opening at a top end face for accommodating a test sample to be analyzed, wherein an outer surface of each of two side walls facing each other in a direction of light irradiation, which is the direction in which measurement light of the analyzer is irradiated, and is a normal direction, when the rectangular cell is mounted in the analyzer, the rectangular cell comprising a low region including a region through which the measurement light is transmitted, and a high region which is a plane region other than the low region, and the plane including the low region located on the inner side surface in the irradiation direction with respect to the plane including the high region.

The rectangular cell according to the first aspect can be mass-produced, and when it is mounted in the analyzer, the region on the outer surface through which the measurement light is transmitted is not easily scratched.

In the rectangular cell according to the first aspect, the configuration in which the low region reaches the closed end face may be adopted as a second aspect.

Further, in the rectangular cell according to the first aspect, the configuration in which the low region does not reach the closed end face may be adopted as a third aspect.

The rectangular cell according to the second aspect is easier to process than the rectangular cell according to the third aspect. On the other hand, the rectangular cell according to the third aspect is less likely to be scratched than the rectangular cell according to the second aspect because the low region does not come into contact with the side surface of the recess of the analyzer when it is mounted in the analyzer.

In the rectangular cell according to any one of the first to third aspects, at each of four corner portions formed inside two adjacent wall surfaces of four wall surfaces at the open top end face, a configuration in which a flat surface or a curved inclined surface relative to both of the two wall surfaces in a shape extending inwardly downward and outwardly upward may be adopted as a fourth aspect.

Further, the present invention provides, as a fifth aspect, a bottomed rectangular cell that is mounted in a photometric analyzer and has an opening at the top end face for accommodating a test sample to be analyzed, includes a flat surface or a curved inclined surface relative to both of the two wall surfaces in a shape extending inwardly downward and outwardly upward, at each of four corner portions formed inside two adjacent walls of four wall surfaces at the open top end face.

In the rectangular cell according to the fourth or fifth aspect, when the test sample to be analyzed is a liquid, the test sample to be analyzed reaches the open top end face of the rectangular cell under capillary action, and thus evaporation of a liquid component and adhesion of a solid component to the open top end face of the rectangular cell is unlikely to occur.

Further, in the rectangular cell according to the fourth or fifth aspect, the configuration by which the flat surface or the curved inclined surface is formed by R chamfering or C chamfering may be adopted as the sixth aspect.

Since the rectangular cell according to the sixth aspect can be manufactured using an existing processing technique, mass production of the rectangular cell is readily achieved.

Further, in the rectangular cell according to any one of the first to sixth aspects, a configuration in which a coating of an elastic material that covers the edge of the open top end face may be adopted as the seventh aspect.

The rectangular cell according to the seventh aspect is less likely to be damaged at the open portion.

### Effect of Invention

According to the present invention, there is provided a rectangular cell that can be mass-produced since the region on the outer surface through which the measurement light is transmitted is not easily scratched when the rectangular cell is mounted in the analyzer.

### BRIEF DESCRIPTION OF THE DRAWINGS

FIG. 1A is a perspective view of a rectangular cell according to an embodiment.

FIG. 1B is a plan view of a rectangular cell according to an embodiment.

FIG. 1C is a front view or a rear view of a rectangular cell according to an embodiment.

FIG. 1D is a right side view or a left side view of a rectangular cell according to an embodiment.

FIG. 1E is a bottom view of a rectangular cell according to an embodiment.

FIG. 2A is an explanatory diagram of an example of a method of forming a mirror-finished surface on an outer surface of a low region of a rectangular cell according to an embodiment.

FIG. 2B is an explanatory diagram of an example of a method of forming a mirror-finishedsurface on an outer surface of a low region of a rectangular cell according to an embodiment.

FIG. 3A is a diagram showing how a rectangular cell according to an embodiment is mounted in an analyzer.

FIG. 3B is a diagram showing how a rectangular cell according to an embodiment is mounted in an analyzer.

FIG. 3C is a diagram showing how a rectangular cell according to an embodiment is mounted in an analyzer.

FIG. 4A is a perspective view of a portion of a top open end face side of a rectangular cell according to an embodiment.

FIG. 4B is a plan view of a rectangular cell according to an embodiment.

FIG. 4C is a vertical cross-sectional view of a rectangular cell according to an embodiment.

FIG. 4D is a vertical cross-sectional view of a rectangular cell according to an embodiment.

FIG. 4E is a vertical cross-sectional view of a rectangular cell according to an embodiment.

FIG. 5A is a diagram showing a state in which a curved surface is formed on an inner edge portion of an open top end face of a rectangular cell according to an embodiment.

FIG. 5B is a diagram showing a state in which a curved surface is formed on an inner edge portion of an open top end face of a rectangular cell according to an embodiment.

FIG. 6 is an explanatory diagram showing that the liquid test sample to be analyzed does not reach an open top end face of a rectangular cell according to an embodiment.

FIG. 7 is a diagram showing a shape of a rectangular cell according to a modified example.

FIG. 8 is a diagram showing a shape of a rectangular cell according to a modified example.

FIG. 9 is a diagram showing a portion of a rectangular cell covered with a coating according to a modified example.

FIG. 10 is a diagram showing a shape of a rectangular cell according to a modified example.

FIG. 11A is a perspective view of a rectangular cell according to the prior art.

FIG. 11B is a plan view of a rectangular cell according to the prior art.

FIG. 11C is a front view or a rear view of a rectangular cell according to the prior art.

FIG. 11D is a right side view or a left side view of a rectangular cell according to the prior art.

FIG. 11E is a bottom view of a rectangular cell according to the prior art.

FIG. 12A is a diagram schematically showing a state in which a rectangular cell according to the prior art is mounted in a recess of an analyzer.

FIG. 12B is a diagram schematically showing a state in which a rectangular cell according to the prior art before being mounted in a recess of an analyzer is viewed from the side.

FIG. 12C is a diagram showing a state in which a rectangular cell according to the prior art has been mounted in the recess of the analyzer.

FIG. 12D is a perspective view of a rectangular cell according to the prior art in a state of being scratched by dust when being mounted in the recess of the analyzer.

FIG. 13 is a diagram showing a shape and an associated problem of an open top end face of a rectangular cell according to the prior art.

### DETAILED DESCRIPTION

The rectangular cell 1 according to an embodiment of the present invention will now be described below.

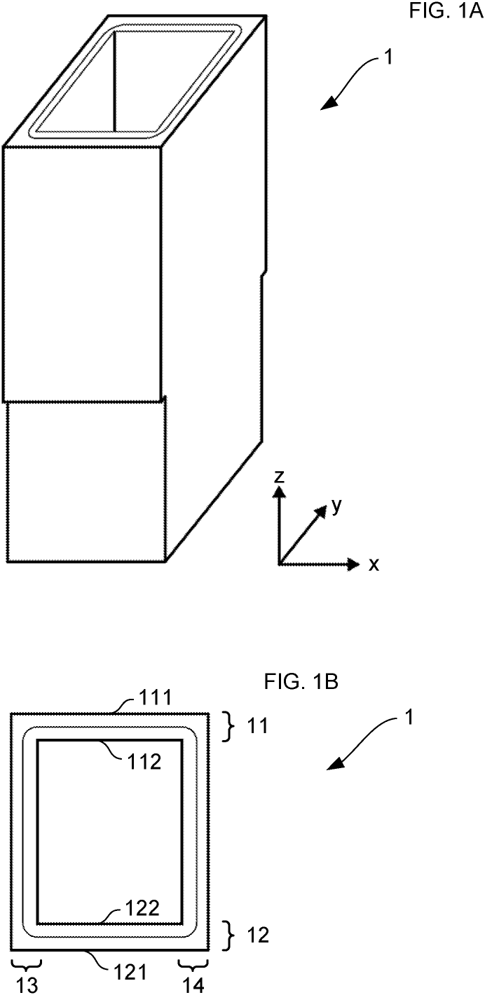

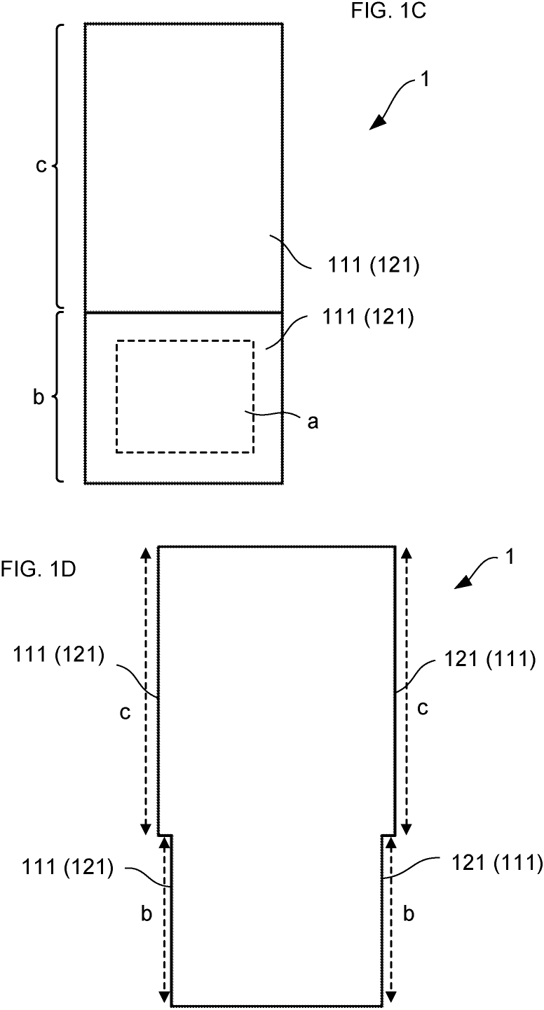

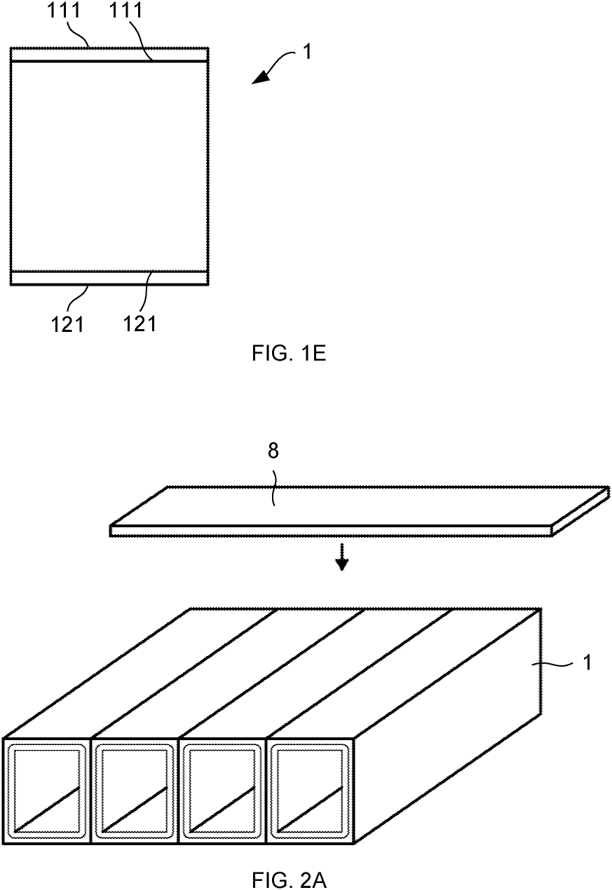

FIGS. 1A to 1E (these figures are collectively referred to as FIG. 1) are diagrams showing the shape of the rectangular cell 1. FIG. 1A is a perspective view of the rectangular cell 1, FIG. 1B is a plan view of the rectangular cell 1, FIG. 1C is a front view or a rear view of the rectangular cell 1, FIG. 1D is a right side view or a left side view of the rectangular cell 1, and FIG. 1E is a bottom view of a rectangular cell 1.

In FIG. 1A, the lower end face of the rectangular cell 1 is closed and the top end face of the rectangular cell 1 is open. Therefore, in FIG. 1A, the z direction indicates the direction from the closed end face to the open top end face. Further, the y direction (an irradiation direction described in the claims) indicates the direction in which the measurement light of the analyzer is irradiated after mounting the rectangular cell 1 in the recess of the analyzer, and the x direction indicates the direction orthogonal to both the z direction and the y direction.

The side wall 11 and the side wall 12 shown in FIG. 1B are two side walls facing each other with the y direction (the irradiation direction) being the normal direction. The inner side surface 112 of the side wall 11 and the inner side surface 122 of the side wall 12 are processed to be mirror-finished surfaces to eliminate bending and reflection of the measurement light as much as possible. As a method of processing the inner side surface 112 and the inner side surface 122 to be mirror-finished surfaces, for example, there is adopted a known method of heating a bottomed tube of quartz glass or borosilicate glass containing a metal inner mold having a mirror-finished surface inside until the bottomed tube reaches a softening temperature, and discharging the air inside the bottomed tube that has reached the softening temperature to the outside by crimping the bottomed tube to the inner mold, then cooling it, and removing the inner mold from the bottomed tube.

The outer surface 111 of the side wall 11 and the outer surface 121 of the side wall 12 both have a low region b and a high region c, which are rectangular planar regions, as shown in FIGS. 1C and 1D. In this application, the “planar region” means a region on a plane without any indentation. The low region b is a region including a region a through which the measurement light is transmitted, and that extends substantially over the entire width of the outer surface 111 or the outer surface 121 in the x direction, and reaches the closed end surface of the rectangular cell 1in the z direction. In other words, the low region b is adjacent to the outer surface of each of the two side walls facing each other (a side wall 13 and a side wall 14 shown in FIG. 1B) of the rectangular cell 1 with the normal direction in the x direction at both end portions in the x direction.

Further, the plane including the low region b of the outer surface 111 is located on the inner side surface 112 relative to the plane including the high region c of the outer surface 111. Similarly, the plane including the low region b of the outer surface 121 is located on the inner side surface 122 relative to the plane including the high region c of the outer surface 121. That is, when the distance from the inside to the outside of the rectangular cell 1 in the x direction is set as the height, the low region b is at a position lower than the high region c. In other words, the length of the low region b in the x direction is substantially the same as the length of the side of the closed end face of the rectangular cell 1 in the x direction.

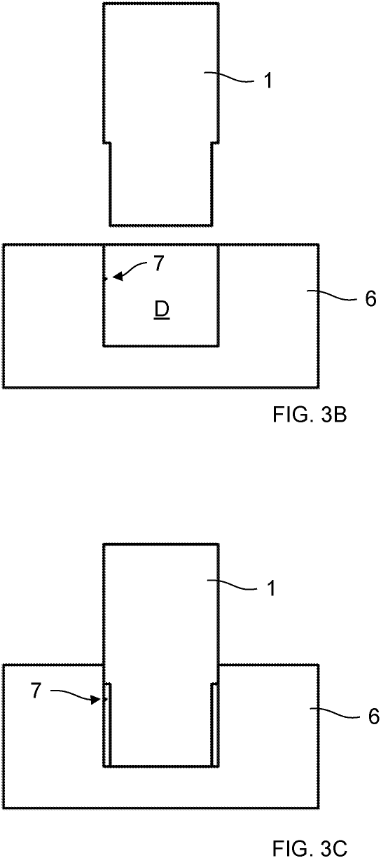

On each of the outer surface 111 and the outer surface 121, the distance between the plane including the low region b and the plane including the high region c, that is, the amount of the low region b formed lower than the high region c inside the rectangular cell 1 (hereinafter, referred to as “the height difference”) is, for example, 0.01 mm. In addition, in FIG. 1 and FIG. 3 described later, the height difference between the low region b and the high region c is shown as greater than the actual height, for simplicity of illustration.

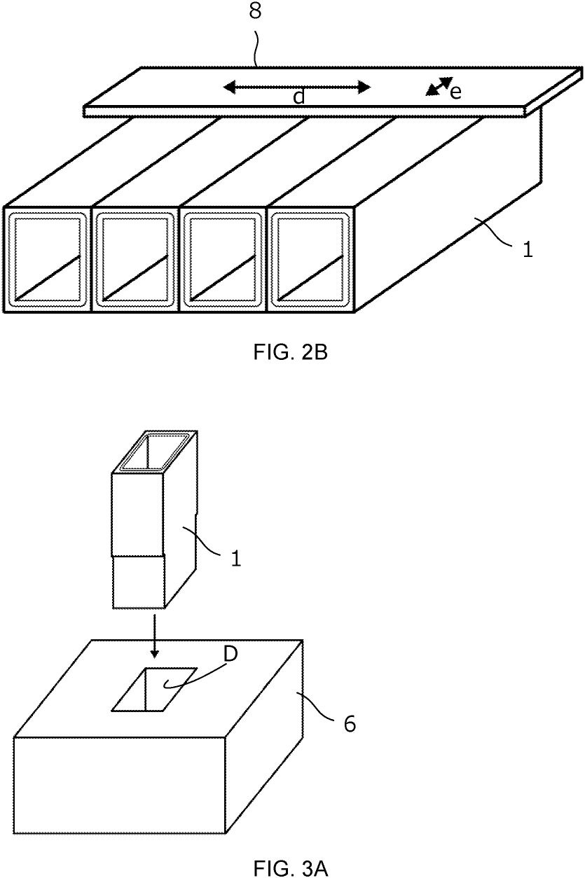

Since the low region b of the outer surface 111 and the outer surface 121 includes the region a through which the measurement light is transmitted, the surface of the low region b is mirror-finished to eliminate bending and reflection of the measurement light as much as possible. FIGS. 2A and 2B are both explanatory diagrams showing an example of a method of forming a low region b of a mirror-finished surface on the outer surface 111 or the outer surface 121 of the rectangular cell 1.

First, as shown in FIG. 2A, each of the open top end face and the closed end face of a plurality of rectangular cells 1 in a state before the low region b is formed are aligned and put together so that their outer surfaces 111 or outer surfaces 121 form one surface each. Next, as shown in FIG. 2B, the abrasive material 8 is pressed against a certain region on the closed end face of the outer surface 111 or the outer surface 121 of the rectangular cells 1 and reciprocated in the direction of the arrow d, thereby forming the low region b. At that stage, the low region b of the outer surface 111 or the outer surface 121 is evenly polished by applying a slight movement to the abrasive material 8 in the direction of the arrow e. By repeating such a polishing process and substituting the abrasive material 8 with one having a finer roughness (count), a mirror-finished surface is attained in the low region b of the outer surface 111 or the outer surface 121.

FIGS. 3A to 3C (these figures are collectively referred to as FIG. 3) are diagrams schematically showing how the rectangular cell 1 is mounted in the recess of analyzer 6. As shown in FIG. 3A, when the rectangular cell 1 is mounted in the recess of analyzer 6, it is mounted from the end face side in the prism-shaped recess D provided in the analyzer 6.

FIG. 3B is a diagram schematically showing a state in which the analyzer 6 and the rectangular cell 1 before being mounted in the analyzer 6 are viewed from the side. Fine hard dust 7 (for example, detached glass particles) having a diameter smaller than the height difference between the low region b and the high region c are adhered to the side surface of the recess D of the analyzer 6 shown in FIG. 3B. FIG. 3C is a diagram showing a state in which the rectangular cell 1 is mounted in the recess D of the analyzer 6 shown in FIG. 3B.

As shown in FIG. 3C, there is a gap between the side surface of the recess D of the analyzer 6 and the low region b of the outer surface 111 of the rectangular cell 1, and between the side surface of the recess D of the analyzer 6 and the outer surface 121 of the rectangular cell 1. Therefore, when the rectangular cell 1 is mounted in the recess D of the analyzer 6, the outer surface 111 or the outer surface 121 may come into contact with dust 7, but dust 7 is not pressed against the outer surface 111 or the outer surface 121 with such force that the outer surface 111 or the outer surface 121 is scratched. Thus, the region a through which the measurement light of the outer surface 111 and the outer surface 121 of the rectangular cell 1 is transmitted is not scratched. If a size of the dust 7 is greater than the height difference between the low region b and the high region c, since the lower end edge of the rectangular cell 1 scrapes off the dust 7 when the rectangular cell 1 is mounted, the region a is not scratched.

In addition to the feature of having the low region b described above, the rectangular cell 1 has a feature different from that of the rectangular cell 5 according to the prior art in the shape of the open top end face.

FIG. 13 is a diagram showing the shape and the associated problem of the open top end face of the rectangular cell 5 according to the prior art. In the rectangular cell 5, a valley portion v is formed where two adjacent wall surfaces are in contact with each other, out of the four wall surfaces. When the test sample to be analyzed contained in the rectangular cell 5 is a liquid, the test sample to be analyzed rises along the valley v under capillary action, reaches the four corner portions of the open top end face of the rectangular cell 5, and then may spread out on the open top end face. In that case, the liquid component of the test sample to be analyzed that spreads out on the open top end face evaporates, and the solid component adheres to the closed end face of the rectangular cell 5. When a plurality of test samples to be analyzed is sequentially analyzed by an analyzer using the rectangular cell 5, if the solid component of the test sample to be analyzed previously analyzed adheres to the closed end face of the rectangular cell 5, there is a risk that the adhered solid components will remain on the end face of the rectangular cell 5 after normal washing, and will mixed with a next test sample to be analyzed.

To solve the above problem, the rectangular cell 1 is formed with the top end portion of the four valley portions v, that is, the rectangular cell 1 has a curved surface inclined relative to both of the two wall surfaces, having a shape that extends inwardly downward and outwardly upward, at each of the four corner portions formed inside the two adjacent wall surfaces of the four wall surfaces of the open top end surface.

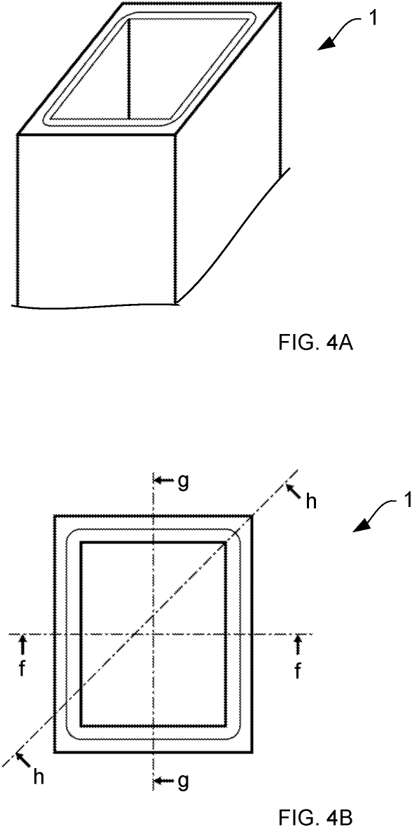

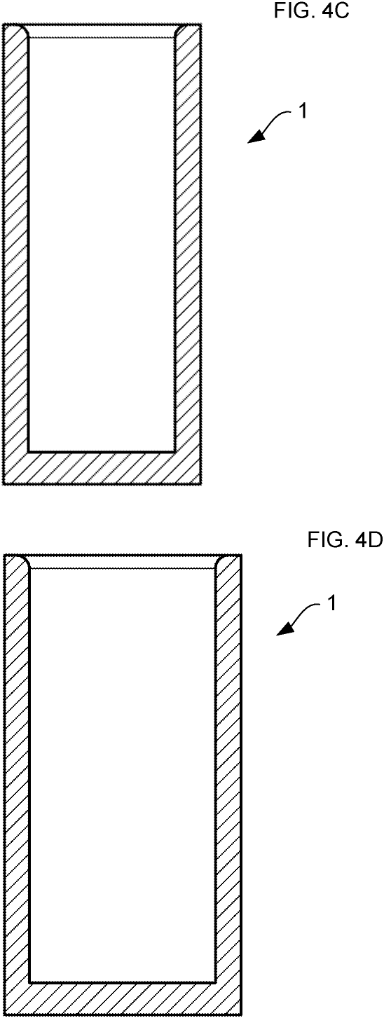

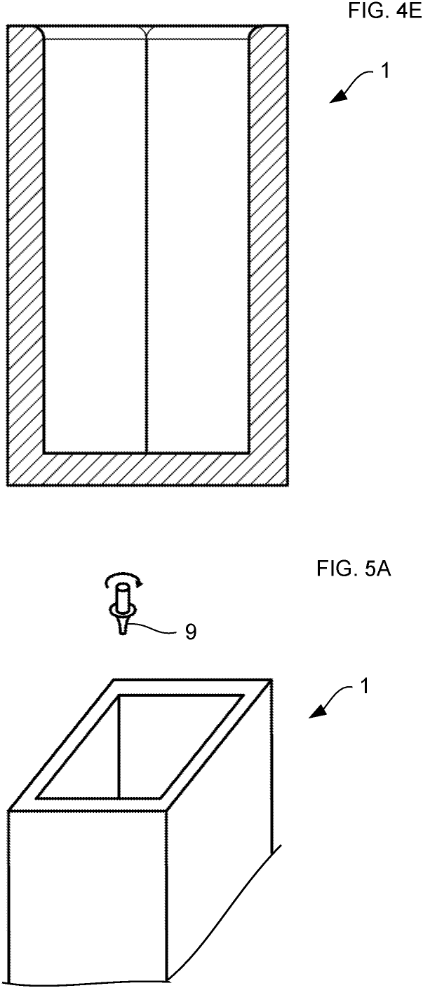

FIGS. 4A to 4E (these figures are collectively referred to as FIG. 4) are diagrams showing the shape of a portion on the open top end face of the rectangular cell 1. FIG. 4A is a perspective view of a portion on the open top end face of the rectangular cell 1, and FIG. 4B is a plan view of the rectangular cell 1. FIG. 4C is a cross-sectional view of the rectangular cell 1 when the rectangular cell 1 is cut in the z direction on the cut surface f shown in FIG. 4B, and FIG. 4D is a cross-sectional view of the rectangular cell 1 when the rectangular cell 1 is cut in the z direction on the cut surface g shown in FIG. 4B. FIG. 4E is a cross-sectional view of the rectangular cell 1 when the rectangular cell 1 is cut in the z direction at the cut surface h shown in FIG. 4B.

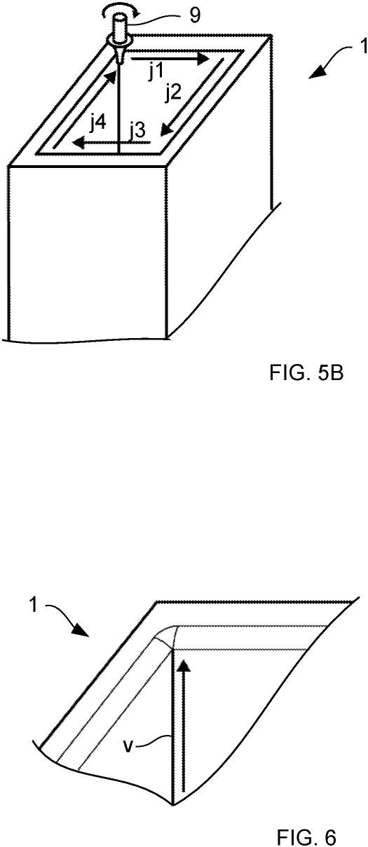

As shown in FIG. 4, an outwardly convex curved surface is formed on the inner edge portion of the open top end face of the rectangular cell 1 over the entire circumference. This curved surface is formed by, for example, R chamfering. FIGS. 5A and 5B are diagrams schematically showing how a curved surface is formed on the inner edge portion of the open top end face of the rectangular cell 1 by R chamfering.

First, FIG. 5A is a diagram showing a rectangular cell 1 in a state before the inner edge portion of the open top end face is polished. As shown in FIG. 5B, while pressing the rotating router bit 9 against the inner edge portion of the open top end face of the rectangular cell 1 in the state of FIG. 5A, for example, as shown by arrows j1 to j4, polishing is performed over the entire circumference of the edge portion. In this case, polishing is performed using the bit 9 whose polishing surface is inwardly curved to be convex. As a result, an outwardly convex curved surface is formed on the inner edge portion of the open end surface of the rectangular cell 1 over the entire circumference.

FIG. 6 is an explanatory diagram showing that the liquid test sample to be analyzed does not reach the open top end face of the rectangular cell 1. In the valley portion v of the rectangular cell 1, capillary action occurs, as is the case with the valley portion v of the rectangular cell 5 according to the prior art. Therefore, the liquid test sample to be analyzed may rise along the valley v. However, in the rectangular cell 1, a fan-shaped curved surface is formed between the upper end of the valley portion v and the open top end surface, and capillary action does not occur on the curved surface. Thus, although the test sample to be analyzed may reach the upper end of the valley portion v of the rectangular cell 1, it does not reach the open top end face and spread out on the end face. Accordingly, the problem that the solid component of the test sample to be analyzed adheres to the rectangular cell 1 and the problem of the solid component remaining in the rectangular cell 1 after normal washing does not occur.

### [Modified Examples]

The embodiments described above can be variously modified within the scope of the technical idea of the present invention. An example of these variations is described below. In addition, the following two or more modified examples may be combined.

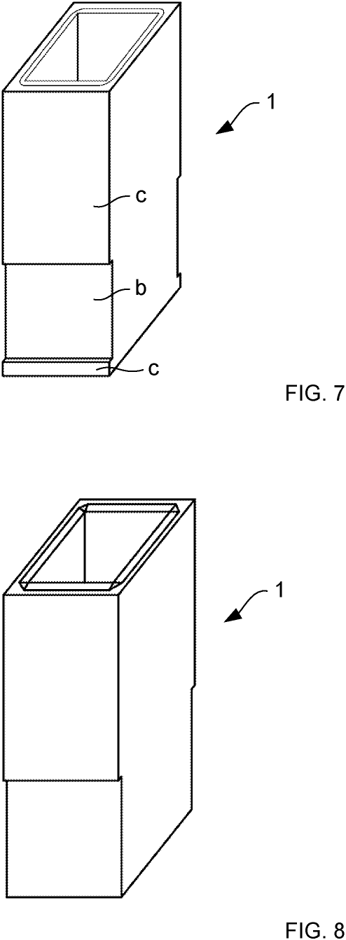

(1) The low region b of the outer surface 111 and the outer surface 121 of the rectangular cell 1 described above reach the closed end face of the rectangular cell 1 in the z-axis direction. The low region b does not have to reach the closed end face of the rectangular cell 1, as long as it is a plane region including the region a through which the measurement light is transmitted. FIG. 7 is a diagram illustrating the shape of the rectangular cell 1 according to this modified example. In the example illustrated in FIG. 7, the high region c is composed of two plane regions.

The rectangular cell 1 (see FIG. 1) according to the above-described embodiment is easier to process than the rectangular cell 1 (see FIG. 7) according to this modified example. On the other hand, in the rectangular cell 1 according to the above-described embodiment, when the rectangular cell 1 is mounted in the recess D of the analyzer 6, the low region b may come into contact with the side surface of the recess D. As a result, the rectangular cell 1 may be slightly scratched. Further, for example, when dust having a large size substantially the same as the height difference between the low region b and the high region c adheres to the side surface of the recess D of the analyzer 6, when the rectangular cell 1 is mounted in the recess D of the analyzer 6, dust is not scraped off by the lower end edge portion of the rectangular cell 1 and may be sandwiched between the side surface of the recess D and the low region b to damage the low region b.

On the other hand, in the rectangular cell 1 according to this modified example, a risk of the low region b coming into contact with the side surface of the recess D is low. Further, dust adhering to the side surface of the recess D of the analyzer 6 is scraped off by the lower end edge portion of the rectangular cell 1 when the rectangular cell 1 is mounted regardless of its size, so that the dust is unlikely to scratch the low region b.

(2) A curved surface is formed on the inner edge portion of the open end face of the rectangular cell 1 described above. Alternatively, an inclined flat surface may be formed on the inner edge portion of the open top end face of the rectangular cell 1. In that case, the inclined plane is formed by, for example, C processing. FIG. 8 is a diagram illustrating the shape of the open top end face of the rectangular cell 1 according to this modified example.

(3) In the above-described rectangular cell 1, a curved surface is formed over the entire circumference of the inner edge portion of the open top end face. Alternatively, a curved surface or a flat surface that is inclined relative to any of the two adjacent wall surfaces that form the four corner portions may be formed, only to these corner portions of the inner edge portion of the open top end face of the rectangular cell 1.

(4) The method for manufacturing the above-mentioned rectangular cell 1 (the method for forming the low region b, the method for forming a curved surface on the inner edge portion of the open top end face, etc.) is an example, and various other methods may be adopted.

(5) In the description of the above-described embodiment, the material of the rectangular cell 1 is not particularly mentioned, but the material of the rectangular cell 1 is not limited, as long as the transmittance of the measurement light meets the required criteria. For example, quartz glass, borosilicate glass, transparent hard plastic and the like can be adopted as the material of the rectangular cell 1.

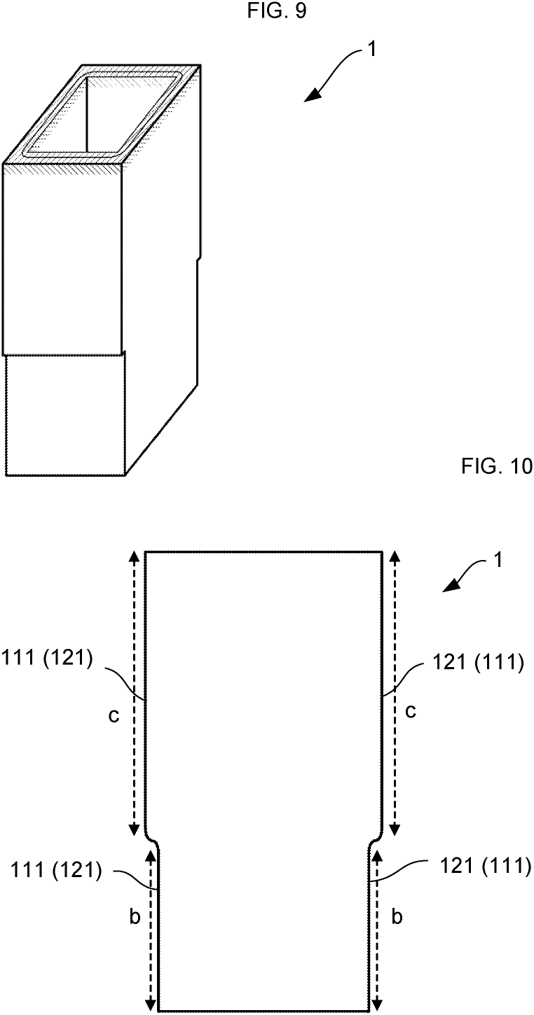

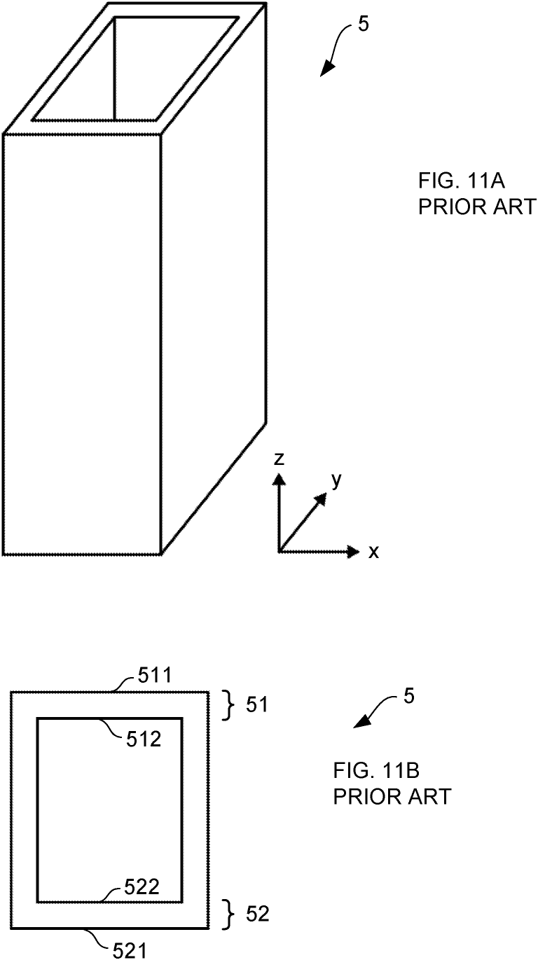

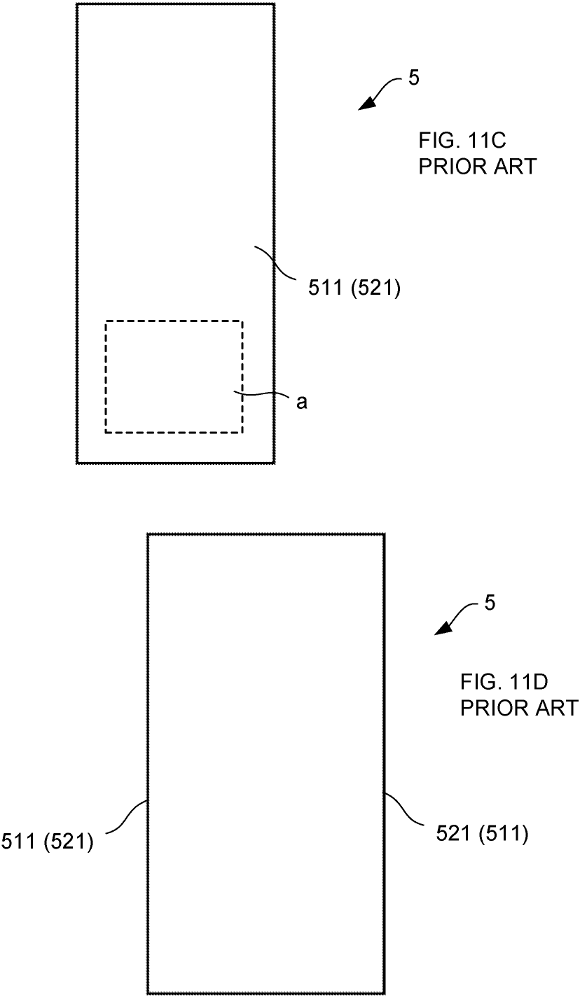

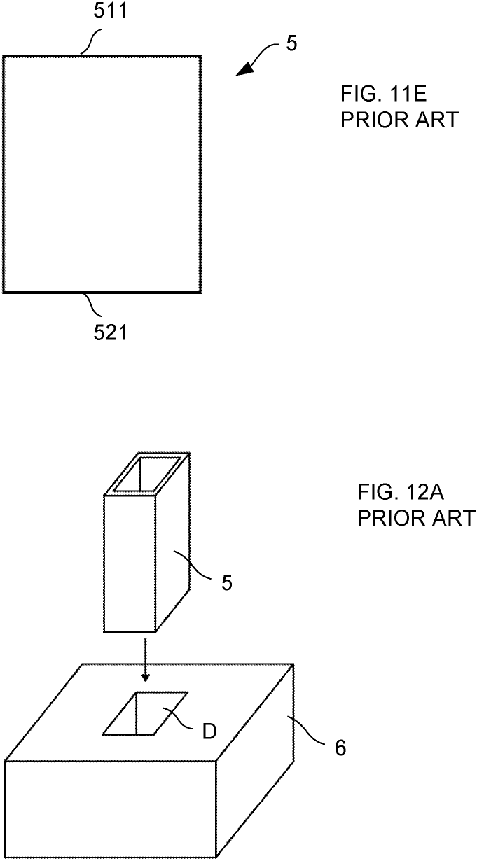

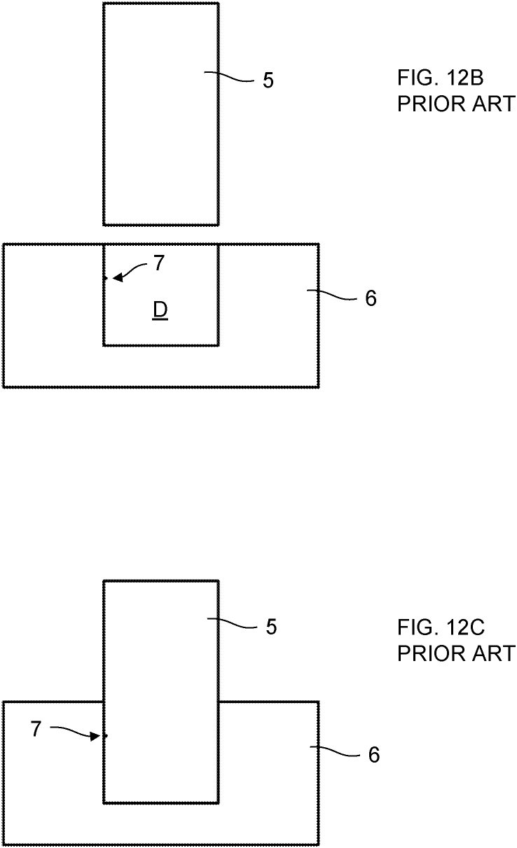

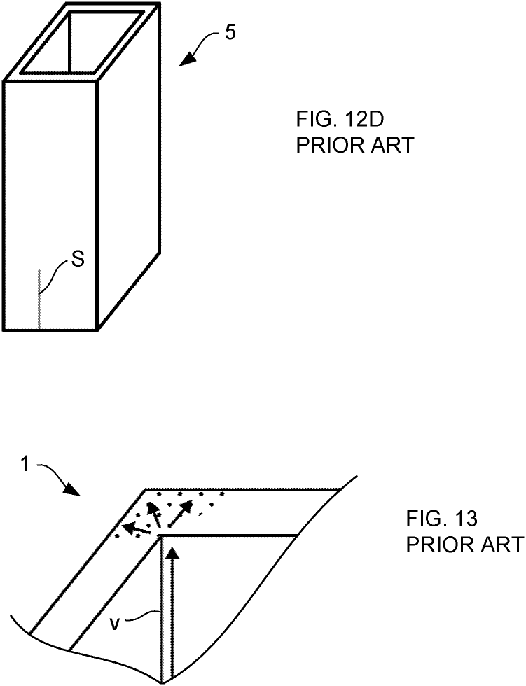

(6) The rectangular cell 1 may be provided with a coating of an elastic material (for example, synthetic rubber) covering a region of the mouth portion, that is, a region including an edge portion of the open top end face. FIG. 9 is a diagram illustrating a region covered with a coating of an elastic material by diagonal lines in the rectangular cell 1 according to this modified example. According to the rectangular cell according to this modified example, even if the open portion comes into contact with something, the open portion is unlikely to be damaged. Further, the coating of the elastic material may be colored. In that case, each of the plurality of rectangular cells can be distinguished by the color of the open portion.

(7) In the rectangular cell 1 according to the above-described embodiment, the outer surface 511 and the outer surface 521 are classified as either the low region b or the high region c. The outer surface 511 and the outer surface 521 may include a region that is not classified as either the low region b or the high region c. FIG. 10 is a right side view or a left side view of an example of the rectangular cell 1 according to this modified example. In the rectangular cell 1 shown in FIG. 10, there is a region connecting the low region b and the high region c between the low region b and the high region c. In the example illustrated in FIG. 10, the region connecting the low region b and the high region c is a curved surface, but this region may be a plane inclined relative to the low region b and the high region c.

1. A rectangular cell with an open top face and a closed bottom face that is mounted in a photometric analyzer and accommodates a test sample to be analyzed by the photometric analyzer,
wherein an outer surface of each of two side walls facing each other which are perpendicular to an irradiation direction in which the photometric analyzer irradiates light for analyzing the test sample when mounted in the photometric analyzer has a low region including a region through which the light is transmitted, and a high region which is a plane region other than the low region, and a plane including the low region is located closer to an inner surface of the side wall in the irradiation direction than a plane including the high region.

2. The rectangular cell according to claim 1, wherein the low region reaches the closed bottom face.

3. The rectangular cell according to claim 1, wherein the low region does not reach the closed bottom face.

4. The rectangular cell according to claim 1, comprising:
at each of four corners formed in the open top face between each pair of two adjacent side walls of four side walls, a flat or curved surface inclined to both of the two adjacent side walls and expanding from a lower inner side to an upper outer side.

5. A rectangular cell with an open top face and a closed bottom face that is mounted in a photometric analyzer and accommodates a test sample to be analyzed by the photometric analyzer, comprising:
at each of four corners formed in the open top face between each pair of twoadjacent side walls of four side walls, a flat or curved surface inclined to both of the two adjacent side walls and extending from a lower inner side to an upper outer side.

6. The rectangular cell according to claim 4, wherein the flat or curved surface inclined to both of the two adjacent side walls is formed by R chamfering processing or C chamfering processing.

7. The rectangular cell according to claim 1, comprising:
a coating of elastic material covering an edge of the open top face.

8. The rectangular cell according to claim 5, wherein the flat or curved surface inclined to both of the two adjacent side walls is formed by R chamfering processing or C chamfering processing.

9. The rectangular cell according to claim 5, comprising:
a coating of elastic material covering an edge of the open top face.
